(19) United States
(12) Patent Application Publication
(10) Pub. No.: US 2018/0078990 A1
(43) Pub. Date: Mar. 22, 2018

(54) METHOD FOR PRODUCING A MOULDED PART, MOULDED PART, TOOL AND PRESS COMPRISING A TOOL

(71) Applicant: SCHULER PRESSEN GMBH, GOEPPINGEN (DE)

(72) Inventors: DANIEL PIETZKA, HEININGEN (DE); MICHAEL WERBS, STUTTGART (DE)

(73) Assignee: SCHULER PRESSEN GMBH, GOEPPINGEN (DE)

(21) Appl. No.: 15/554,713

(22) PCT Filed: Feb. 22, 2016
(86) PCT No.: PCT/DE2016/100076

§ 371 Date: Aug. 31, 2017

(30) Foreign Application Priority Data
Mar. 2, 2015 (DE) 10 2015 102 908.1

(51) Int. Cl. B21D 35/00; B21D 22/02; B23K 26/24

(52) U.S. Cl. CPC B21D 35/006; B23K 26/24; B21D 22/02

(57) ABSTRACT

A method for producing a formed part. The method includes providing a metal sheet made of a metal. The metal sheet is formed as a planar base body having a material thickness that is less than length measurements of a surface of the metal sheet. The metal sheet has a larger surface both on a top side and on a bottom side than surfaces determining the material thickness. A material-bonded application is performed by applying a foreign structure onto the surface of the metal sheet. The metal sheet is formed after applying the foreign structure to provide the formed part.

### CROSS REFERENCE TO PRIOR APPLICATIONS

This application is a U.S. National Phase application under 35 U.S.C. § 371 of International Application No. PCT/DE2016/100076, filed on Feb. 22, 2016 and which claims benefit to German Patent Application No. 10 2015 102 908.1, filed on Mar. 2, 2015. The International Application was published in German on Sep. 9, 2016 as WO 2016/138892 A1 under PCT Article 21(2).

### FIELD

The present invention relates to a method for producing a formed part in which a metal sheet is processed, the metal sheet comprising a metal and forming a planar base body with a material thickness that is less than the length measurements of a surface of the metal sheet, the metal sheet having a greater surface at a top side and at a bottom side than at the surfaces determining the material thickness. The present invention further relates to a formed part and a press with a tool.

### BACKGROUND

Metal sheets are more specifically flat finished rolling mill products made of metal which are customarily provided as plates and/or coils. Metal sheets are used in manufacturing in many sectors of industry, such as automotive engineering, domestic appliance engineering, shipbuilding, and mechanical engineering. The components produced from metal sheets are subjected to different local loads depending on their intended use.

There is an increasing need for composite materials in addition to lightweight construction and the associated conservation of energy. A disadvantage of composite materials is an abrupt transition between the different materials since mechanical loads frequently lead to problems at the transitions between materials.

There is therefore a need for metal sheets with continuous property profiles that can be tailored to specific applications. Materials with flexibly designable properties are also referred to as materials with graded properties.

The following various industrial processing methods have to date been used to adjust graded component properties for metal sheet parts.

One method uses a custom-made metal sheet blank which is customarily composed of materials of different quality and/or sheet thicknesses (tailored blank). This prefabricated semi-finished product is then formed into the desired component, for example, by deep drawing.

The individual metal sheet blanks are welded together in a tailored welded blank, which is generally carried out by laser beam welding. The graded component properties are thus achieved, after forming, by way of a planar composite of metal sheets of different measurements and/or different materials.

The graded component properties can also be achieved using a variedly rolled metal sheet strip. In such a tailor rolled blank, different metal sheet thicknesses of a metal sheet strip are achieved by rolling the rolls back and forth so that homogenous and/or continuous transitions between two thicknesses can be achieved. The disadvantage here is that only one material is used.

The general disadvantage of the aforementioned method is that metal sheets are composed of different materials and/or different metal sheet thicknesses that are assembled into a planar shape. During the subsequent forming process of the metal sheet into a formed part and/or during later use of the formed part, there is a risk that the composite metal sheets will tear, in particular at the transition points, and that more material is necessary due to their planar shape.

Specific weak spots can also appear in the component during forming, in which, for example, thinning and/or fraying and/or tearing can locally occur. Such a weak spot can be, for example, the area of a door lock of a car door to be manufactured.

The aforementioned methods are limited with regard to these weak spots since an adaptation to local loads can only be carried out through the choice of the material of the metal sheet or the metal sheet thickness.

EP 0 911 426 B1 describes a method for manufacturing a formed part in which a powdery additive is spread onto a base body, for example, a metal sheet, by thermal spraying, without melting the powder particles and without manufacturing a material bond between two materials. The coated base body is then deformed and the base body is removed.

DE 44 19 652 A1 describes providing partial surfaces of the structured areas with different structures that are adapted to the main degree of deformation intended for the respective partial surface in order to improve vibration behavior, the strength, and in particular the diagonal rigidity of lightweight components, as well as to improve the manufacture of lightweight components with three-dimensionally deformed metal sheets from a plate-shaped formed part, which, at least in certain areas, has a three-dimensional structure that is open in at least two directions set at an angle relative to each other in the plane of the plate-shaped form element.

DE 10 2004 051 848 B3 describes a method for manufacturing multi-layered metal sheet structures in which a multi-layered metal sheet structure consisting of at least one base plate and at least one reinforcing plate is manufactured, wherein the reinforcing plate is joined with the base plate through a joining process and a yield strength of the multi-layered metal sheet structure in an edge area and/or a central area of the reinforcing plate is lower than in the remaining area of the reinforcing plate, and the multi-layered metal sheet structure is then deformed through a forming process. DE 10 2004 051 848 B3 also describes a multi-layered metal sheet structure that is, for example, manufactured using the aforementioned method.

EP 0 911 426 B1 describes a method for manufacturing formed parts, wherein a base body is coated via a thermal spraying, wherein a powdery additive is channeled onto the surface of the base body to be coated via a gas, without the powder particles of the additive being melted in the gas jet and without the base body being reinforced by spray coating to the desired thickness, wherein the base body has a lesser thickness than the layer applied by thermal spraying.

Due to the mentioned methods and disadvantages, achieving graded properties of a component through the prefabrication of a metal sheet is in practice only possible to a limited extent.

### SUMMARY

An aspect of the present invention is to improve upon the disadvantages of the prior art.

In an embodiment, the present invention provides a method for producing a formed part. The method includes providing a metal sheet comprising a metal. The metal sheet is formed as a planar base body having a material thickness that is less than length measurements of a surface of the metal sheet. The metal sheet comprises a larger surface both on a top side and on a bottom side than surfaces determining the material thickness. A material-bonded application is performed by applying a foreign structure onto the surface of the metal sheet. The metal sheet is formed after applying the foreign structure to provide the formed part.

### BRIEF DESCRIPTION OF THE DRAWINGS

The present invention is described in greater detail below on the basis of embodiments and of the drawings in which:

FIG. 1 shows a schematic representation of a prefabricated metal sheet which is the starting point of the method of the present invention;

FIG. 2. shows a schematic representation of the first step of the present application where a material-bonded application is performed by applying a foreign structure onto a surface of the prefabricated metal sheet;

FIG. 3 shows a schematic representation of the second step of the present application where the prefabricated metal sheet is formed to a car door;

FIG. 4 shows a schematic representation of a prefabricated metal sheet which is the starting point of the method of the present invention;

FIG. 5 shows a schematic representation of the first step of the present application where a material-bonded application is performed by applying a foreign structure onto a surface of the prefabricated metal sheet; and

FIG. 6 shows a schematic representation of the second step of the present application where the prefabricated metal sheet is formed to a B-column.

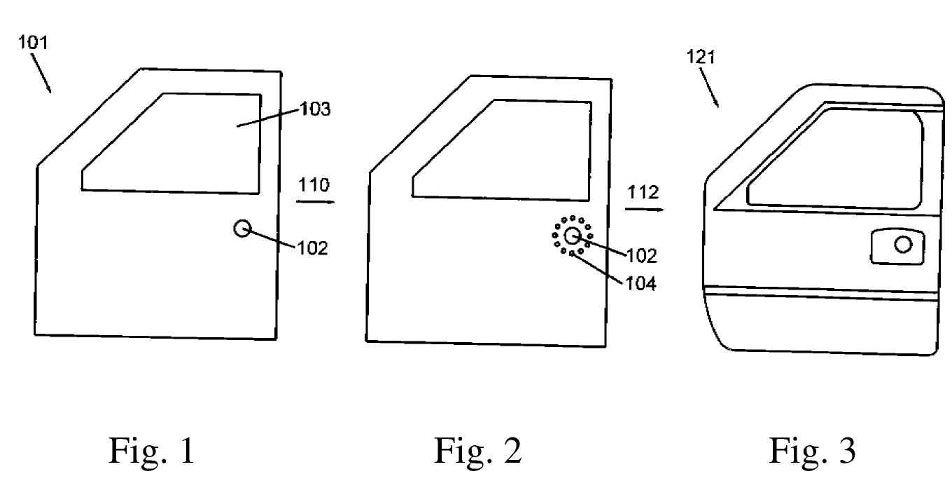

### DETAILED DESCRIPTION

In an embodiment, the present invention provides a method for producing a formed part in which a metal sheet is processed, the metal sheet comprising a metal and forming a planar base body with a material thickness that is less than the length measurements of a surface of the metal sheet, the metal sheet having a greater surface both on a top side and a bottom side than at the surfaces determining the material thickness, comprising the following steps:
providing a material-bonded application of a foreign structure onto a surface of the metal sheet; and
forming the metal sheet after the application of the foreign structure so that the formed part is provided after the forming process.

Through the targeted, material-bonded application of a foreign structure onto the surface of a metal sheet, the metal sheet is more specifically pre-fabricated so that, after the forming, the metal sheet has received graded properties. This allows for a flexible fabrication of metal sheets before the forming process.

Different material combinations can in particular be used and, first and foremost, a foreign structure with different material properties can be applied in a material-bonded manner onto the surface of the metal sheet. This consequently influences the material thickness, the material composition, and/or the surface structure of the metal sheet.

The type of material-bonded application of the foreign structure allows for a flexible design of the component. Optimized formed part properties can be specifically adjusted in a targeted manner through the material-bonded application of a foreign structure in accordance with the intended use of the formed part and its local loads. The properties can thus be improved locally and in a targeted manner through the application of structures.

The method according to the present invention is material and resource-effective since no large-scale overlap of two materials is necessary for forming the structure, and the second material can be used very locally.

It is particularly advantageous that known weak spots, in which damage such as a thinning, fraying and/or tearing of the formed part can occur after forming, are thus prevented.

An idea of the present invention is based on the fact that the component and forming properties of metal sheets after the application of a material-bonded foreign structure onto the surface of the metal sheet are achieved by a combination of structured grading and forming.

Not only the properties of the formed part to be produced, but also the forming process itself can thus be influenced and/or improved. The forming properties can also be expanded.

This results in fewer formed parts with production defects, so that productivity is increased and costs are lowered. The following terms must be explained:

A “formed part” is in particular a work piece which, as a result of forming, is plastically produced through a targeted deformation of a metal sheet. A formed part is therefore a component with almost finished or finished work piece shapes and/or work piece geometries.

A “metal sheet” is in particular a flat finished rolling mill product made of metal, which is more specifically provided as a plate and/or a coil. A metal sheet is more specifically a flat base body and/or a flat structure. A metal sheet can more specifically consist of a single metal sheet or of several connected metal sheets and/or several joined metal sheets and/or a metal sheet plate. A metal sheet can thus be more specifically provided as tailor welded and tailor bonded blanks. The metal sheet can be a thin metal sheet with a thickness of less than 3.00 mm and/or a thick metal sheet with a thickness greater or equal to 3.00 mm. A metal sheet can also be provided as a foil with a thickness of less than 60 μm. Metal sheets can in particular be made of metallic materials such as steel, copper and/or aluminum.

A “metal” in particular refers to chemical elements whose atoms connect to each other to form a crystalline structure with freely moving electrons (metallic bonding). Metals must here be understood as heavy metals, light metals, noble metals, non-noble metals and/or semi-metals as well as their alloys. A metal can in particular be provided in a solid and/or a liquid state. Examples of metals are iron, nickel, copper, chromium, aluminum, and titanium; examples of alloys are iron-nickel (FeNi), chromium-nickel (CrNi), and chromium-nickel-molybdenum (CrNiMo).

The “material thickness” in particular indicates the thickness of the metal sheet, and refers more specifically to the material thickness perpendicular to the surface of the metal sheet. The material thickness in particular refers to that measurement which is smaller than the length measurements of a surface of the metal sheet, the metal sheet having a substantially greater surface respectively on its upper side and bottom side than on the surfaces defining the material thickness. If a metal sheet lies horizontally, the material thickness is in particular the vertical material thickness, which can also be referred to as edge height.

The “length measurement” in particular refers to the longest length of the metal sheet in one orientation. Length measurement more specifically refers to the distance between one edge and the opposite edge of a surface of the metal sheet.

A “surface” of a metal sheet is in particular to be understood as the plane that results from the two longest length measurements (length and width) of the metal sheet.

An “upper side” more specifically refers to the side of the metal sheet, which, as a surface, is located above and which is therefore visible when the metal sheet lies horizontally, as a flat base body.

The “bottom side” is more specifically that side of a flat horizontally placed metal sheet which is oriented downwards and is therefore not visible.

The “surface” is more specifically the surface area of the metal sheet and thus a measure of the size of the surface.

A “material-bonded” application more specifically means that the foreign structure is applied to the surface of the metal sheet so that the foreign structure and the metal sheet are more specifically held together by atomic or molecular forces. Through the material-bonded application, the foreign structure and the metal sheet are more specifically joined in a non-detachable manner so that the foreign structure and the metal sheet can only be separated by destroying the connection point. A material-bonded application can more specifically be carried out by welding, for example, by a welded seam.

A “foreign structure” is more specifically a material which has a different spatial structure and/or composition than the metal sheet. A foreign structure more specifically has a different geometric shape, another material, and/or another design. A foreign structure can, for example, be a (imprinted) T-beam, a double T-beam, a ribbing, or a welding spot, which is applied onto the metal sheet by material bonding. The foreign structure can in particular have one or several different materials which differ from each other or from the metal sheet material so that the produced formed part is a hybrid or composite material component.

“Forming” is more specifically a production method in which metals/alloys are plastically given a different shape in a targeted manner. A metal sheet is in particular converted into a formed part via forming. The forming process can more specifically be deep-drawing, and/or pressing. The forming process can in particular be a cold forming process in which the metal sheet is supplied to the forming process in a cold state, for example, at room temperature. The forming process can also be a warm forming process and/or a hot forming process wherein, in the latter case, the metal sheet is heated up prior to forming to a temperature that lies, for example, above the recrystallization temperature.

In an embodiment of the method for producing a formed part of the present invention, a powdery material and/or a liquid material and/or a strip-shaped material and/or a wire-shaped material can, for example, be used as a foreign structure before or during the application onto the metal sheet.

An optimal prefabrication and structuring of the metal sheet can be achieved by using and applying the material in different states (in powder form, solid, liquid) and different shapes (amongst others strip-shaped, wire-shaped).

Different materials and thus different structures can in particular be locally applied onto the metal sheet in a material-bonded manner. Targeted properties can thereby be bestowed onto the future formed part by way of the different materials and the various material properties.

This pre-fabrication of the metal sheet allows for the production of the future formed part as a hybrid and/or composite material.

A “powdery material” is more specifically a very fine-grained bulk material. A powdery material more specifically has a particle diameter of less than 100 μm. The powdery material can more specifically be aluminum, stainless steel, tool steel, and/or titanium particles with or without a binding agent. It is also possible to use synthetic material particles, carbon fibers, glass fibers, and/or aramid fibers, and/or ceramic particles as a powdery material.

The “strip-shaped material” and/or the “wire-shaped material” can be a metal strip and/or a metal wire, for example, made of stainless steel, tool steel, aluminum, copper, and/or titanium.

In order to achieve a permanent bond between the foreign structure and the metal sheet, the material-bonded application of the foreign structure is carried out in an additive and/or a generative manner, in particular by laser deposition welding and/or by selective laser sintering.

Due to the additive and/or generative application of the foreign structure, there is no need for any special shaping tools, other than the foreign structure, that would have to store the respective geometry of the formed part.

This allows for a quick and cost-effective application of the foreign structure onto the metal sheet. The application of the foreign structure can also be carried out very flexibly and individually for each metal sheet.

It is advantageous that the application of the foreign structure is carried out, based on computer-stored data models, directly from the foreign structure, by a chemical and/or physical process.

In addition to the application of the foreign structure, a structuring, for example, a ribbing, of the metal sheet surface can be simultaneously carried out by generative application.

By implementing the material-bonded application of the foreign structure by way of an additive and/or generative method, a permanent connection between the foreign structure and the metal sheet is achieved in a simple manner, while simultaneously applying local patterns.

The foreign material is molten and/or non-detachably joined through the additive and generative application, which is necessary for the subsequent production of the formed part through forming.

The additive and/or generative application can also be economically used for producing unique copies, small series, or for the one-off production of parts of great geometric complexity.

The terms “additive” and/or “generative” refer more specifically to an additive and/or generative production method in which foreign structures made of shape-less materials (liquids, powder and/or similar materials) or shape-neutral materials (strip-shaped and/or wire-shaped) are applied onto the surface of the metal sheet via chemical and/or physical processes, in particular based on computer stored data models. Generative and/or additive production methods more specifically include selective laser melting and/or laser deposition welding and/or selective laser sintering. While additive methods in particular lead to the build-up of additional layers, other properties can also be achieved, in particular through generative methods.

In “laser deposition welding”, a surface application onto a work piece takes place, in particular, by melting and simultaneous application of a material. This material can in particular be provided in a powdered form, for example, as a metal powder, or as a welding wire and/or welding strip. The heat source in laser deposition welding is more specifically a high-power laser, for example, a diode laser or a fiber laser. Laser deposition welding can more specifically be used for producing layers and/or free-form two-dimensional and/or three-dimensional structures.

“Selective laser sintering” is in particular a method for manufacturing spatial structures by sintering using a powdery source material. Laser sintering is more specifically a generative layer-building method in which the foreign structure is built layer by layer onto the metal sheet and three-dimensional geometries of the foreign structure are formed, as needed, through the action of the laser beams. After the application of the powdery foreign structure, the powder bed is melted and/or sintered in accordance with the layer structure through a control of the laser beam.

In an embodiment of the method for producing a formed part of the present invention, the metal sheet can, for example, be locally structured.

Structures, such as, for example, ribbings, which will later lead to an increase of the rigidity of the formed part after forming, can thereby be applied locally onto the metal sheet. Functional structures, such as gearings, can also be applied onto the metal sheet.

The structuring expands the design possibilities through the local application of material onto the metal sheet in addition to adjusting graded properties of the future formed part.

The metal sheet can thereby also be further designed during the prefabrication of the metal sheet.

“Structuring” is to be understood as the targeted creation of a geometric structure of the foreign structure and/or of the metal sheet.

The forming process is influenced in a targeted manner by way of the applied foreign structure in order to achieve the greatest possible flexibility when producing the formed part and in order to produce durable hybrid and/or composite components and/or composite formed parts.

The forming behavior can thus be influenced in a targeted manner by the shape and/or the type and/or the properties of the applied foreign structure.

In an embodiment, the present invention provides a formed part which is produced using the previously described method, the formed part being created via the forming process.

A formed part can thus be produced from a hybrid and/or composite material.

A formed part can thus be locally reinforced in a targeted manner, for example, in weak spots, which are known to be prone to thinning and/or tearing or fraying. The resistance and durability of the formed part is thus increased.

The formed part can more specifically be adapted in a targeted manner to its purpose and the loads and produced with varying properties. The formed part can also be cost-effectively produced in small numbers.

In an embodiment of the present invention, the formed part, after forming, features a targeted structure and/or graded properties due to a foreign structure applied before forming, so that the formed part has targeted strength properties and/or targeted rigidity properties.

The desired properties of the formed part after forming can thus be obtained in a targeted manner through the application of the foreign structure.

After forming, the applied foreign structure more specifically has a targeted structure and/or graded properties which impart targeted strength and/or rigidity properties onto the component.

It can be advantageous if the formed part has graded properties, which means that a property, such as, for example, the strength or the transition between two materials, is constant and/or homogenous across the surface of the formed part. The occurrence of a tear, for example, at the transition between two materials during forming or during subsequent use of the formed part, can thus be avoided. Durable properties of the formed part can thus be achieved.

The formed part comprises a hybrid material and/or a composite material in order to provide for a lightweight construction and to save energy.

Parts of the formed part that are subject to lower loads can thus be made of aluminum, while highly loaded parts can be made of steel or even titanium.

It is therefore also possible, for example, to produce the formed part from a hybrid material such as fiber-reinforced aluminum.

By applying the foreign structure onto the metal sheet, a composite material made of these two materials can in particular be produced by way of the material-bonded connection, the composite material having other properties than the foreign structure and the metal sheet separately.

Via the permanent connection of the foreign structure and the metal sheet, an increase of the strength and/or an increase of the rigidity of the resulting composite material can thus be achieved at the transition between the foreign structure and the metal sheet.

A “hybrid material” is in particular a composite of two or several components, which belong in particular to different families of materials. A hybrid material can in particular be a combination of metallic and ceramic, ceramic and polymer, or polymer and metallic elements. A hybrid material in particular has a laminar structure with at least two materials of different main groups, which is macroscopically homogenous, microscopically and/or quasi homogenous or heterogeneous.

A “composite material” (also referred to as a “compound material”) is in particular a material composed of two or more constituent materials which have other material properties than its individual components. These materials are in particular provided at a macroscopic scale. Material properties and geometries of the components, in particular, play a decisive part in the properties of the composite material. A composite material can in particular be a particle composite, a fiber composite, a laminated material, an infiltrated composite, and/or a structural composite. The materials in the composite material can in particular be polymers (synthetic materials), metallic, ceramic, and/or organic materials.

In an embodiment, the present invention provides a tool for forming a metal sheet for producing a formed part in accordance with a previously described method, the tool forming a metal sheet with an applied foreign structure so that, after forming, a formed part with a specific structure and/or graded properties is provided.

An optimal forming of the foreign structure and/or of the metal sheet into a formed part can be achieved through a targeted adaptation of the tool to the applied foreign structure.

The later structure and/or shape and/or properties of the formed part can thus be influenced by the design of the tool.

In order to adjust the properties of the metal sheet with the applied foreign structure in a targeted manner, and/or to keep the shape of the applied foreign structure, the tool is arranged so that the applied foreign structure is not in contact with the tool or partially in contact with the tool or entirely in contact with the tool during forming.

The geometry and the properties of the applied foreign structure is modified in a targeted manner during pressing depending on the type of contact with the tool.

If the applied foreign structure is completely free of contact with the tool, the foreign structure is not pressed, so that the applied foreign structure largely retains is shape. This is desired, for example, when functional structures such as gearings have been produced during the application of the foreign structures, which must not be modified by pressing.

A complete contact of the tool with the applied foreign structure on the metal sheet is in contrast particularly desired when an identical deformation must be achieved, when very continuous transitions must be produced, and/or when specific graded properties must be obtained. In the latter case, the pressing power continuously decreases, for example, from the foreign structure across the transition to the metal sheet.

In an embodiment, the present invention provides a press with a tool, which is arranged so that the step of forming can be implemented according to a previously described method, the tool being arranged so that the formed part can be produced by forming the metal sheet with the applied foreign structure.

With a press, the previously prefabricated metal sheet with an applied foreign structure can be transformed into a desired formed part. The press with the tool is therefore configured to achieve the desired shape and the desired local properties.

With such a press with a tool, identical formed parts can be produced in very high numbers, and formed parts with different properties can be produced with the same tool by varying the press power.

In an embodiment of the press, during pressing, a surface with an applied foreign structure on the metal sheet can, for example, be impinged with the same force as a surface of the metal sheet without an applied foreign structure, or a surface of the metal sheet with an applied foreign structure can, for example, be impinged with a lesser or stronger force than a surface of the metal sheet without an applied foreign structure.

The maximum pressing force that can be effectively applied to a working point depends on the size of the press. The amount of force applied to a respective local point is defined by the design and shape of the tool. In places where the metal sheet with the applied foreign structure is to be deformed, the tool is correspondingly in contact, during pressing, with the metal sheet with the applied foreign structure. Using different forming processes of the foreign structure and the metal sheet, graded properties of the formed part can be achieved. It is also possible to not form the foreign structure at all. This can be appropriate, for example, when functional structures such as gearings, which must retain their shape during forming, have been applied onto the metal sheet by way of the foreign structure. The foreign structure is not subjected to forming in this case.

In the case of a targeted increase in strength, it is advantageous if the foreign structure and the metal sheet are formed, for example, with the same force. In the case of a foreign structure that has, for example, a greater hardness than the metal sheet, it is in contrast advantageous if the foreign structure is impinged with a higher force than the metal sheet alone.

Depending on the additive and/or generative application process, the forming process of the foreign structure and the metal sheet and the applied forces can thus be adjusted locally and in a targeted manner to the desired changes of shape and/or the desired property changes.

The present invention is described in more detail below based on exemplary embodiments.

A pre-cut metal sheet 101 made of steel comprises a cut-out for a door lock 102 and a cut-out for a window 103.

In a subsequent additive processing step 110, twelve welding spots (welding points 104) are placed as additively applied foreign structures onto the pre-cut metal sheet 101 around the cut-out for the door lock 102.

The deep-drawn car door 121 is then formed by deep-drawing 112. Due to the tensile-compressive forming, the welding points 104 lead to a reinforcement of the composite of the welding points 104 with the metal sheet 101 around the cut-out for the door lock 102.

This reinforcement prevents the occurrence of tearing and/or fraying at the cut-out for the door lock 102 during the deep-drawing process 112 and during later use of the car door of a produced car.

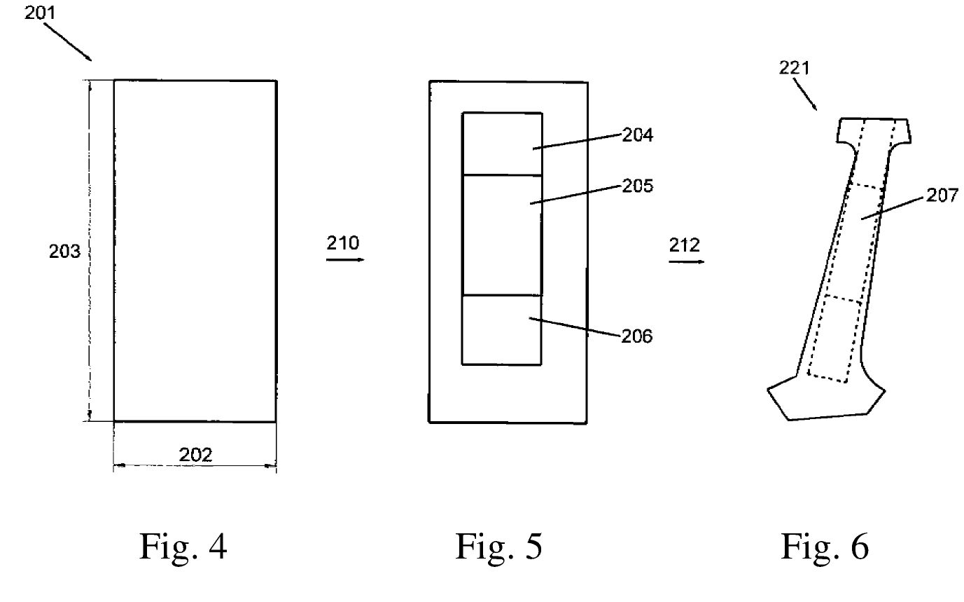

A metal sheet 201 made of steel has a width 202 and a length 203. The width 202 and the length 203 form the corresponding surface, which is visible as an upper side (FIG. 4).

In the subsequent processing step of the laser deposition welding process 210, an aluminum structure 204, a titanium structure 205 and again an aluminum structure 206 are produced on the metal sheet 201 in a respectively pre-defined area, respectively, by the application of aluminum particles, the application of titanium particles, and the application of aluminum particles.

The aluminum and titanium particles are applied by laser deposition welding process 210 so that continuous transitions to the metal sheet 201 and between the aluminum structure 204, the titanium structure 205 and the aluminum structure 206 are carried out.

The metal sheet 201 with the applied foreign structures 204, 205 and 206 is then formed into a pressed B column 221 by pressing 212. A graded reinforcement of the pressed B column is thus achieved in the area 207, in which the titanium particles were previously applied. The graded reinforcement 207 continuously transitions, above and below, into an area with a lesser reinforcement, in which the aluminum particles were previously applied. In the middle area by graded reinforcement 207, in which there usually is a weak spot, the pressed B column 221 is reinforced and can be subjected to greater stresses.

The present invention is not limited to embodiments described herein; reference should be had to the appended claims.

### LIST OF REFERENCE NUMBERS

101 pre-cut metal sheet
102 cut-out for a door lock
103 cut-out for a window
104 welding point (as an additively applied foreign structure)
110 additive processing step
112 deep-drawing
121 deep-drawn car door
201 metal sheet
202 width
203 length
204 aluminum structure
205 titanium structure
206 aluminum structure
207 graded reinforcement
210 laser deposition welding process
212 pressing
221 pressed B-column

What is claimed is:

1-12. (canceled)

13. A method for producing a formed part, the method comprising:
providing a metal sheet comprising a metal, the metal sheet being formed as a planar base body having a material thickness that is less than length measurements of a surface of the metal sheet, the metal sheet comprising a larger surface both on a top side and on a bottom side than surfaces determining the material thickness;
performing a material-bonded application by applying a foreign structure onto the surface of the metal sheet; and
forming the metal sheet after applying the foreign structure to provide the formed part.

14. The method as recited in claim 13, wherein at least one of a powdery material, a liquid material, a strip-shaped material, and a wire-shaped material is used as the foreign structure prior to or during the applying of the foreign structure onto the surface of the metal sheet.

15. The method as recited in claim 13, wherein the material-bonded application of the foreign structure is performed in at least one of an additive manner and in a generative manner.

16. The method as recited in claim 13, wherein the material-bonded application of the foreign structure is performed via a laser deposition welding.

17. The method as recited in claim 13, wherein the metal sheet is locally structured.

18. The method as recited in claim 13, wherein the foreign structure applied influences a forming behavior of the metal sheet in a targeted manner.

19. A formed part produced by the method as recited in claim 13.

20. The formed part as recited in claim 19, wherein, after the forming, the formed part comprises at least one of a targeted structure and a graded property due to the applying of the foreign structure prior to the forming so that the formed part comprises at least one of targeted strength properties and targeted rigidity properties.

21. The formed part as recited in claim 19, wherein the formed part comprises at least one of a hybrid material and a composite material.

22. A tool for forming a metal sheet for producing a formed part using the method as recited in claim 13, the tool being configured to form the metal sheet with an applied foreign structure so that, after the forming, the formed part comprises at least one of a specific structure and graded properties.

23. The tool as recited in claim 22, wherein the tool is arranged so that, during the forming, the foreign structure applied does not contact the tool, or partially contacts the tool, or entirely contacts with the tool.

24. A press comprising a tool,
the tool being configured to form a metal sheet with an applied foreign structure using the method as recited in claim 13 so that, after the forming, a formed part comprises at least one of a specific structure and graded properties, and
the press being arranged so that the forming can be performed using the method as recited in claim 13,
wherein, the tool is arranged so that the formed part can be produced by forming the metal sheet with the applied foreign structure.

25. The press as recited in claim 24, wherein, during the forming,
the surface of the metal sheet with the foreign structure applied is impinged with a force which is equal to a force applied to a surface of the metal sheet without the foreign structure applied, or
the surface of the metal sheet with the foreign structure applied is impinged with a force which is less than or stronger than a force applied to a surface of the metal sheet without the foreign structure applied.
